(19) United States
(12) Patent Application Publication
(10) Pub. No.: US 2016/0123702 A1
(43) Pub. Date: May 5, 2016

(54) STORAGE CLIPBOARD WITH QUICK-ACCESS WEAPON HOLDER

(71) Applicant: Unseen Tactical, LLC, Cleveland, OH (US)

(72) Inventors: Joseph R. Zeno, Akron, OH (US); Kenneth Baker, Warren, OH (US)

(21) Appl. No.: 14/927,214

(22) Filed: Oct. 29, 2015

Related U.S. Application Data
(60) Provisional application No. 62/073,941, filed on Oct. 31, 2014.

(51) Int. Cl. F41C 33/06; B42F 9/00

(52) U.S. Cl. CPC F41C 33/06; B42F 9/002

(57) ABSTRACT

A storage-style clipboard has a quick-access weapon holder assembly. When triggered, the assembly moves from a concealed position to an accessible position. The weapon holder assembly may be accessed through a side or end wall of the clipboard box. The movement of the weapon holder assembly is actuated without the need for the user to remove his hand from the normal case-carrying position. The disclosure provides a recess accessible through one of the sides of the clipboard box with a grip and a trigger for release of the weapon holder sheltered in the recess. The recess provides protection for the user's hand and further hides from view the user's actions in releasing the weapon.

### CROSS REFERENCE TO RELATED APPLICATIONS

This application claims the benefit of U.S. Provisional Patent Application Ser. No. 62/073,941 filed Oct. 31, 2014; the disclosures of which are incorporated herein by reference.

### BACKGROUND OF THE DISCLOSURE

1. Technical Field

The disclosure generally relates to concealed weapon carriers and, more particularly, to a weapon holder concealed in a storage-style clipboard in a manner that allows the holder of the clipboard to obtain quick-access to a weapon in a quick and natural movement. The disclosure specifically relates to the use of a protected inset handle and trigger configuration for such a clipboard and an inset door configuration.

2. Background Information

An increasing number of jurisdictions allow citizens to carry concealed weapons and firearms. Some casual carriers do not wish to carry their weapon on their body but desire a method to carry the weapon in a ready-access location.

Other persons who need ready-access to a firearm or other weapon are security personnel charged with protecting dignitaries, businessmen, facilities, or government officials. These security personnel may carry one weapon in a traditional belt or shoulder holster while desiring ready access to another weapon. These persons also benefit from having ready access to a ballistic shield.

Many police officers and security personnel find themselves in confrontational or potentially confrontational situations where the police officer or security personnel is carrying a storage-style clipboard. A storage clipboard generally includes one or more integral storage boxes for transporting various accessories such as blank paper or forms, pens, pencils, erasers, rulers, calculators, etc. The writing surface of the clipboard is provided with a spring retaining clip for securing papers and is mounted by a hinge to a shallow rectangular box that defines portions of the storage boxes. A person holding a storage clipboard with one hand and writing with the other hand cannot readily draw a holstered weapon without providing a series of movements that telegraph the person's intent to a third party. This situation also occurs when the person is holding a storage clipboard with one hand a flashlight in another hand. When an officer is investigating a scene at night, the officer often holds a flashlight that illuminates the scene while taking notes on the clipboard. An officer in this situation finds himself at an undesirable disadvantage if he needs to quickly draw a weapon. Another common situation is when an officer approaches a driver's door of an automobile while carrying a storage clipboard and a flashlight during a traffic stop. Drawing a holstered weapon in these situations is not ideal.

### SUMMARY OF THE DISCLOSURE

The disclosure provides configurations for a storage-style clipboard that have a quick-access weapon holder assembly. When triggered, the assembly moves from a concealed position to an accessible position. The weapon holder assembly may be accessed through a side or end wall of the clipboard box. The weapon carried by the weapon holder assembly may be a firearm, a chemical-based defense weapon, a baton, or an electricity-based (electroshock) weapon. The weapon holder assembly may include a holster designed to secure the weapon in the manner of a traditional holster so that the weapon is securely held by the weapon holder assembly and so the weapon does not unintentionally fall out of the holder assembly during normal use of the case. The movement of the weapon holder assembly is actuated without the need for the user to remove his hand from the normal case-carrying position. The disclosure provides a recess accessible through one of the sides of the clipboard box with a grip and a trigger for release of the weapon holder sheltered in the recess. The recess provides protection for the user's hand and further hides from view the user's actions in releasing the weapon.

The disclosure provides a storage clipboard having a quick-access weapon holder assembly wherein the storage clipboard has an exterior appearance that is the same as a conventional storage clipboard so as to not raise awareness of the existence of the weapon to a person viewing the container.

In one configuration, the actuator is a pivoting trigger disposed within the recess. The trigger can be manipulated while the user is holding the grip. The trigger allows the user to actuate the weapon deployment with a finger of the hand holding the clipboard while grasping the weapon with the other hand. The clipboard may be configured to be carried by either hand of the user. The user may select to carry the clipboard in the user's weak hand such that the weapon is deployed for grasping by the user's strong hand. For example, a left-handed person will carry the case in his right hand.

In each clipboard configuration, the weapon may be held within a traditional holster such that the weapon and holster may be move rapidly to the accessible position without causing the weapon to fall out of the holster. Such holsters may accommodate a weapon with lights or sights. In the configurations wherein the weapon holder assembly includes a holster, the retention force of the holster may be adjustable. The assembly is designed in such a way that different holsters suited for different manufactures, models and calibers of weapons may be changed out to allow the case to deploy different weapons.

The different configurations may include anti-ballistic protection panels or the walls of the clipboard may be fabricated from or include anti-ballistic materials so that the clipboard may be used as a shield by the user after the weapon has been removed from the clipboard. One configuration provides an additional layer of protection over the grip recess.

The preceding non-limiting aspects, as well as others, are more particularly described below. A more complete understanding of the processes and the security insert and packaging configuration can be obtained by reference to the accompanying drawings, which are not intended to indicate relative size and dimensions of the assemblies or components thereof. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a rear perspective view of an exemplary configuration of a storage clipboard with the back panel removed.

FIG. 2 is a view similar to FIG. 1 with a protective panel installed over the rear of the grip recess.

FIG. 3 is a right side view of FIG. 1 showing the side of the grip and the trigger.

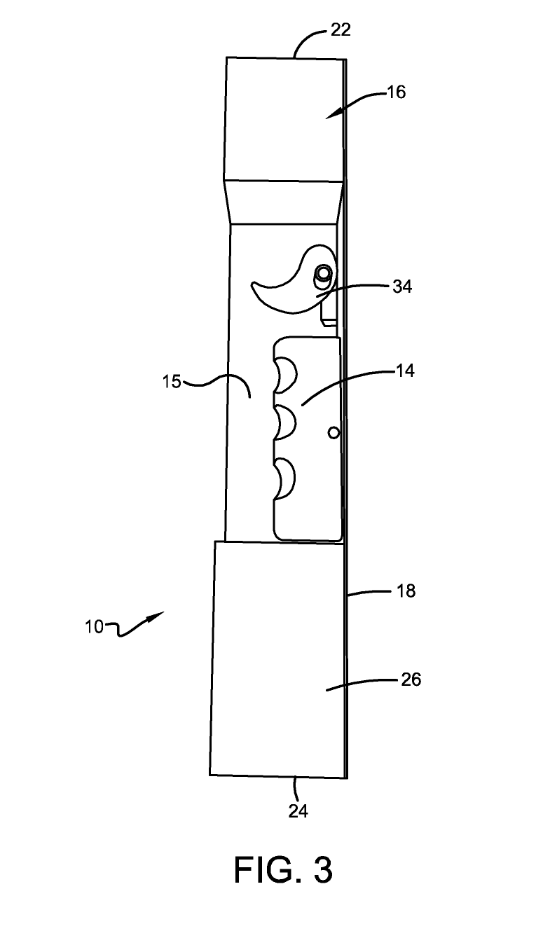

FIG. 4 is a left side view of FIG. 2.

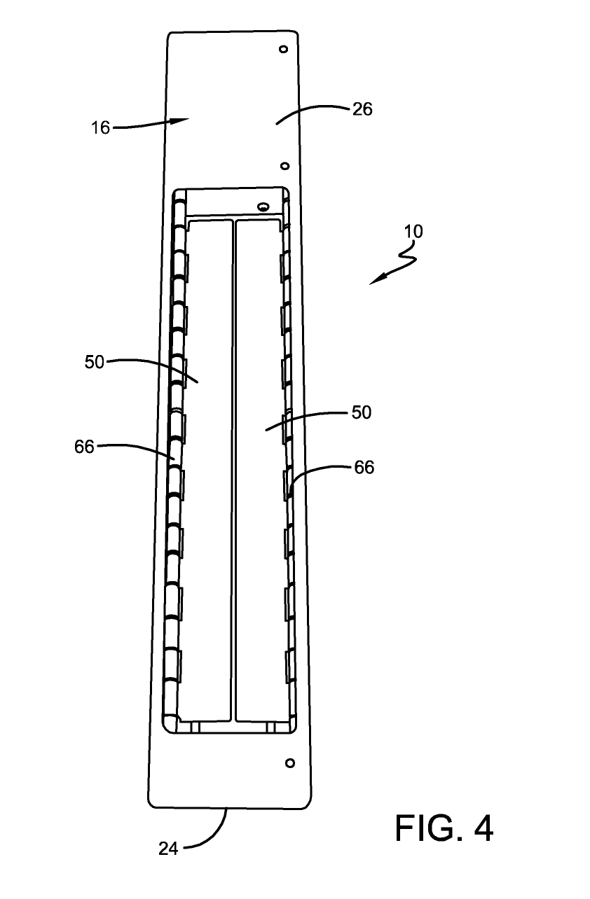

### DESCRIPTION OF THE PREFERRED EMBODIMENT

An exemplary storage-style clipboard (generally referred to herein as a case, a container, a clipboard, a storage clipboard, or a storage-style clipboard) having a quick-access weapon holder assembly is indicated generally by the numeral 10 in the accompany drawings. Clipboard 10 may be a hard-sided container in the shape of a traditional storage clipboard that has an upper writing surface with a biased clip combined with at least one integral storage box. In each of the configurations described herein, clipboard 10 includes a weapon holder assembly 12 that is movable between a concealed position to an accessible position through a wall or panel of clipboard 10. Weapon holder assembly 12 is configured to hold a firearm or a less-than-lethal device such as an electroshock weapon, a tear gas canister, a pepper spray canister, a knife, or any of a variety of batons. The movement of the weapon holder assembly 12 is actuated without the need for the user to remove his hand from the hand's normal carrying position on clipboard 10. Further, the accessible position of weapon holder assembly 12 positions the weapon in a quick-access location for the user's other hand. The user may thus quickly deploy a weapon without signaling his intent to a third person. The hand's normal carrying position for clipboard 10 is one wherein the user's hand is holding a grip 14 disposed in a recess 15 accessible through one of the side panels of clipboard 10. Clipboard 10 provides for delivery of the weapon to a location proximate the person's writing hand when clipboard 10 is held in this manner.

Clipboard 10 generally includes a body 16 that defines at least one storage chamber wherein the weapon is held and recess 15 wherein grip 14 is disposed. Grip 14 is positioned inwardly of the outer perimeter of clipboard 10 or grip 14 is disposed along a portion of the outer perimeter. With grip 14 disposed in recess 15, the user's hand is protected and the movement required to trigger the weapon is concealed. Body 16 may be fabricated from a rigid material such as a metal or a plastic. Body 16 is generally in the form of a six-sided rectangular box and thus includes front 18 and rear 20 panels, a top end wall 22, a bottom end wall 24, and a pair of sidewalls 26. Front panel 18 includes a clip to hold paper or reports that are used with clipboard 10. Rear panel 20 is removable but may be secured with a plurality of fasteners that have security heads to prevent ready access to the weapon carried by clipboard 10.

In the exemplary configuration, recess 15 is accessible through side wall 26 opposite sidewall 26 through which the weapon moves from the concealed position to the accessible position. Recess 15 is generally rectangular, but also can be rounded or trapezoidal. Grip 14 is cantilevered within recess 15 so that a user can position his fingers around grip 14 and behind front panel 18. Recess 15 is deep enough to accommodate the user's knuckles. The user's thumb may be positioned on the outwardly-facing side of grip 14. Grip 14 can define spaced recesses to provide grip and comfort to the user's fingers.

Clipboard 10 includes an actuator 34 for deploying weapon holder assembly 12. The exemplary configuration of clipboard 10 depicted in the drawings is a version for a right-handed user wherein actuator 34 is positioned forwardly of grip 14 when grip 14 is grasped by the user's left hand with the outer surface of front panel 18 facing the user's chest. This leaves the user's right hand near the sidewall 26 opposite recess 15 when the user is writing (or performing another task) such that the deployment of the weapon through the sidewall minimizes the motion required by the user to access the weapon. In the exemplary configurations, actuator 34 is pulled like a trigger causing a shaft to rotate and release weapon holder assembly 12. Actuator 34 may be manipulated with the user's finger or thumb. Actuator 34 is disposed within recess 15 inwardly of the outer perimeter of clipboard 10.

Body 16 may define a plurality of storage compartments such that the weapon holder assembly 12 may be separated from the storage of items. A separate compartment may be used to conceal weapon holder assembly 12. The weapon may be secured within a secure weapon container within body 16 that forms a separated container within clipboard 10. The secure weapon container prevents the weapon from being seen when clipboard 10 is opened during normal use. The weapon container also prevents items stored inside clipboard 10 from interfering with the weapon during normal use of clipboard 10. The secure weapon container may be secured with a lock (key or combination) that secures the container.

Clipboard 10 may be held with a single hand and used as an anti-ballistic shield. Clipboard 10 also may include a neck strap that allows the user to position clipboard 10 in front of his chest when the clipboard is release by both hands. Body 16 may thus include integrated anti-ballistic panels in at least one major wall panel or all major walls. Body 16 may be manufactured from materials known to stop bullets or may be formed to include layers of such materials. When clipboard 10 has anti-ballistic properties, it may be held as a shield both before and after the weapon has been deployed. When clipboard 10 holds a firearm, the process of accessing the firearm and moving clipboard 10 up in front of the user are parts of the same motion. The user may then hold clipboard 10 in front of him as a shield with his hand on grip 14.

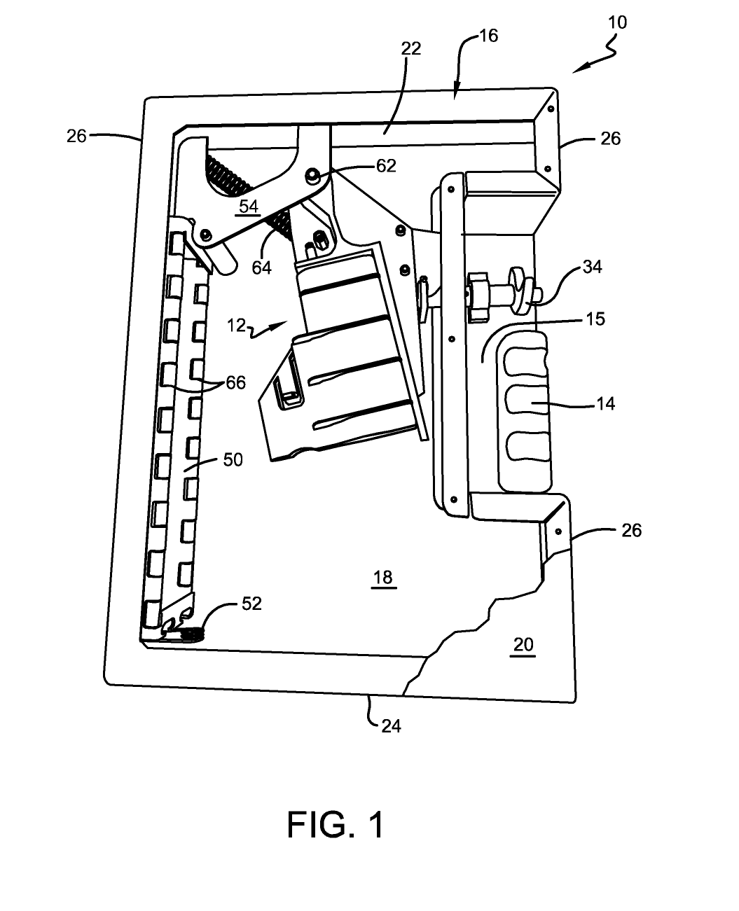

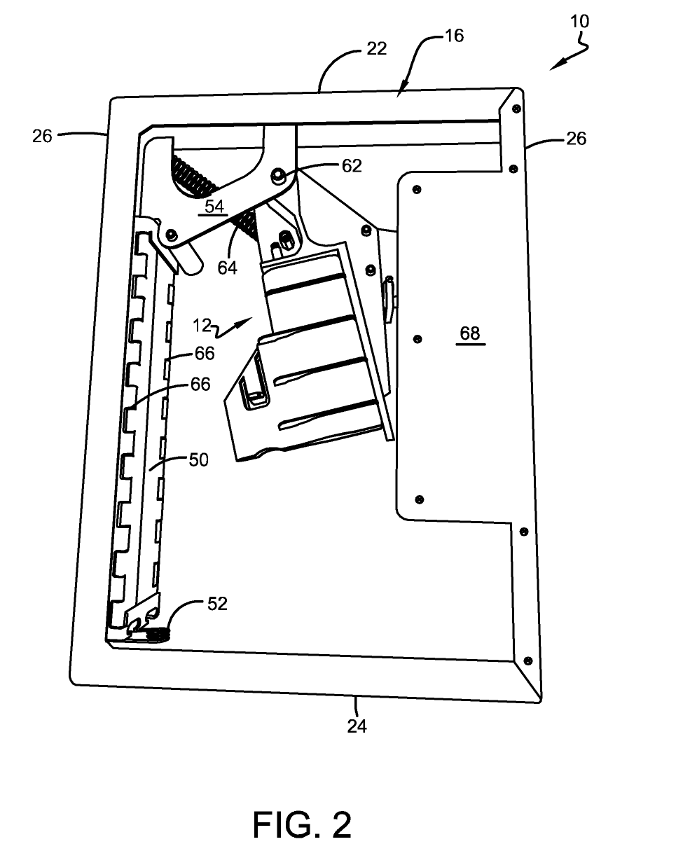

Weapon holder assembly 12 is configured to extend at least a portion of the weapon through an opening in body 16 where it can be grasped by the user. At least one door panel 50 is used to close the opening. In the exemplary configuration, a pair of door panels 50 are used. Door panels 50 pivot open away from each other and do not extend outside of the outer perimeter of the clipboard body when they are open so that the user does not hit his hand on the doors. These door panels are inset from the side wall 26. These door panels allow the weapon to move through the opening without the door panels extending outwardly from the outer perimeter of the clipboard body. FIG. 1 shows door panels 50 open and FIG. 2 shows door panels 50 closed. Door panels may be spring assisted with a biasing mechanism 52 so they stay shut and pop open.

Weapon holder 12 is pivotably carried by a base 54 that is secured to body 16. Base 54 supports a weapon holder with a hinge pin 62 that optionally includes bearings so that the movement of weapon holder assembly 12 is smooth and reliable.

Weapon holder assembly 12 is biased toward the accessible position with at least one biased member 64. Biased member 64 may be a coil spring, a torsion spring, a leaf spring, a folded or rolled section of flat spring steel, or other biasing devices known in the art. Biased member 64 also may be a piston-cylinder mechanism that is biased toward the extended position. Biased member 64 also may be replaced with a motor used to drive assembly 12 to the accessible position.

When the weapon carried by assembly 12 is a firearm, weapon holder assembly 12 includes the portion of a traditional holster that is specifically configured for the firearm being carried. Such traditional holsters securely retain the firearm and minimize the likelihood that the firearm will become loose when carried within clipboard 10. The retention force of this holster may be adjusted. The use of the traditional holster allows the user to change the type of firearm used with clipboard 10 by swapping the holster as needed. In some configurations, the holster itself is hinged to base 54.

In the exemplary configuration, door panels 50 are connected to body 16 with hinges 66 disposed parallel to sidewall 26. Hinges 66 are offset and generally parallel to the longitudinal dimension of sidewall 26. In the closed condition, door panels 50 are generally parallel to sidewall 26 and perpendicular to bottom panel 20. When weapon holder assembly 12 is in the concealed position, door panels 50 may close the opening in body 16 and function as part of the wall of body 16 through which weapon is accessed.

In any of these configurations, a safety latch may be provided. Safety latch may be a mechanical locking element that must be moved prior to moving actuator 34. In another configuration, the safety latch is controlled by a fingerprint reader which scans the user's fingerprint and matches it with a recorded image before allowing the user to deploy the weapon.

An extra panel 68 may be disposed over recess 15 to provide extra protection for the user's hand. Panel 68 is disposed under panel 20.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A storage clipboard device with a quick access weapon holder; the device comprising:
a body defining a storage chamber and having a front panel that defines a writing surface with a clip adapted to hold paper over the writing surface; the body defining an outer perimeter;
a weapon holder assembly carrying a weapon in a concealed position within the storage chamber in a manner that allows the holder of the clipboard to obtain quick-access to a weapon in a quick and natural movement when the weapon holder assembly is in an accessible position; and
the body defining a handle recess accessible through a portion of the outer perimeter of the body; a handle disposed within the recess; the handle being protected by a portion of the body.

2. The device of claim 1, further comprising a trigger for the weapon holder assembly; the trigger being disposed within the recess with the handle; wherein the trigger is disposed next to the handle such that the trigger can be actuated while the user is holding the handle.

3. The device of claim 1, wherein the body includes first and second doors that are movable between closed and open conditions; the first and second doors being moved from the closed configurations to the open configuration by the movement of the weapon holder assembly from the concealed position to the accessible position.

4. The device of claim 3, wherein the first and second doors pivot in opposite directions.

5. The device of claim 1, wherein the body includes a sidewall and a rear panel; the handle being accessed through the sidewall; the body including an extra panel disposed between the handle and the rear panel.

6. The device of claim 1, wherein the handle extends rearwardly away from the front panel.

7. A storage clipboard device with a quick access weapon holder; the device comprising:
a body defining a storage chamber;
the body having a front panel, a rear panel, and first and second side walls;
a weapon holder assembly selectively movable between concealed and accessible positions; the weapon holder being disposed within the storage chamber when it is in the concealed position;
the body defining a handle recess between the front panel and the rear panel; the handle recess being accessible through a portion of the first side wall; and
a handle disposed within the recess.

8. The device of claim 7, wherein the handle extends rearwardly away from the front panel.

9. The device of claim 8, wherein the handle is protected by a portion of the body.

10. The device of claim 9, further comprising an actuator for the weapon holder assembly; the actuator being disposed within the recess with the handle; wherein the actuator is disposed next to the handle such that the actuator can be actuated while the user is holding the handle.

11. The device of claim 10, wherein the body includes first and second doors that are movable between closed and open conditions; the first and second doors being moved from the closed configurations to the open configuration by the movement of the weapon holder assembly from the concealed position to the accessible position.

12. The device of claim 11, wherein the first and second doors pivot in opposite directions.

13. The device of claim 12, further comprising an extra panel disposed between the handle and the rear panel.

14. The device of claim 13, wherein the rear panel includes an anti-ballistic member.

15. A storage clipboard device with a quick access weapon holder; the device comprising:
a body defining a storage chamber;
the body having a front panel, a rear panel, and first and second side walls;
a weapon holder assembly selectively movable between concealed and accessible positions; the weapon holder being disposed within the storage chamber when it is in the concealed position;
the body defining a handle recess between the front panel and the rear panel; the handle recess being accessible through a portion of the first side wall;
a handle disposed within the recess;
the second side wall defining an opening; and
a door assembly movable between open and closed conditions; the closed condition of the door assembly covering the opening in the second side wall.

16. The device of claim 15, wherein the handle is connected to the front panel.

17. The device of claim 16, wherein the handle is protected by a portion of the body.

18. The device of claim 15, further comprising an actuator for the weapon holder assembly; the actuator being disposed within the recess with the handle; wherein the actuator is disposed next to the handle such that the actuator can be actuated while the user is holding the handle.

19. The device of claim 15, wherein the body assembly includes first and second doors that are movable between closed and open conditions; the first and second doors pivoting in opposite directions.

20. The device of claim 15, further comprising an extra panel disposed between the handle and the rear panel.

21. A self-defense storage clipboard device comprising:
a body defining a storage chamber and having a front panel that defines a writing surface with a clip adapted to hold paper over the writing surface; the body defining an outer perimeter; and
the body defining a handle recess accessible through a portion of the outer perimeter of the body; a handle disposed within the recess; the handle being protected by a portion of the body.

22. The device of claim 21, wherein the body includes a sidewall and a rear panel; the handle being accessed through the sidewall; the body including an extra panel disposed between the handle and the rear panel.

23. The device of claim 22, wherein the handle projects rearwardly away from the front panel.

24. The device of claim 22, further comprising an extra panel disposed between the handle and the rear panel.

25. The device of claim 24, wherein the rear panel includes an anti-ballistic member.
